(19) United States
(12) Patent Application Publication
(10) Pub. No.: US 2015/0023749 A1
(43) Pub. Date: Jan. 22, 2015

(54) TAPPING DEVICE AND METHOD OF USE

(71) Applicant: Speedtap Industries Inc., Vancouver (CA)

(72) Inventor: Joshua Wheatley, Vancouver (CA)

(21) Appl. No.: 14/383,858

(22) PCT Filed: Mar. 1, 2013
(86) PCT No.: PCT/CA2013/050156

§ 371 Date: Sep. 8, 2014

Related U.S. Application Data
(60) Provisional application No. 61/616,358, filed on Mar. 27, 2012.

(51) Int. Cl. B23G 5/06; B23G 1/26; B23G 1/16

(52) U.S. Cl. CPC B23G 5/06; B23G 1/16; B23G 1/26; B23G 2200/46
USPC 408/1 BD; 408/222

(57) ABSTRACT

A tapping device for use with a variety of standard drivers. The tapping device has an elongate body having a first end and a second end. A thread cutting portion is provided toward the first end, an end section for fitting to a drive tool is provided at the second end, and a shank portion is deposed between the cutting portion and the end section. A flared stop is provided on the shank adjacent to the end section. The end section being a hex head which will operated with standard drive tool such as impact wrenches or traditional sockets and wrenches.

### FIELD

The present invention relates to thread tapping devices and a method of using a thread tapping device.

### BACKGROUND OF THE INVENTION

A tap is used to cut a thread on the inside surface of a hole. The process of cutting threads using a tap is called tapping. Typically manually operated hand taps have been used to created threaded bores.

To use a tap, the tap is placed in a predrilled hole and rotated. As the tap rotates, it cuts threads into the inside of the hole. As it rotates, it cuts away small particles of metal called chips. The tap is provided with several flutes that allow the cutaway chips to escape from the hole. If the flutes become clogged with chips, the tap will bind and can break. It is necessary to periodically reverse rotation to break the chip formed during the cutting process to prevent the clogging or “crowding” that can cause breakage.

As a result, considerable skill is needed when using hand taps to avoid breaking them. This is especially so in the case of the smaller sizes. If a tap breaks off in a hole, it can be very difficult or even impossible to remove the broken piece.

Furthermore, conventional hand driven taps are rotated around a hole at irregular speeds which can cause the tap to break.

As a result, the use of conventional hand taps is time consuming and requires a skilled technique.

Powered tap devices are known such as that taught by U.S. Pat. No. 7,565,935, however they are specialized and expensive. It is also known to use a drill press or vertical mill however those methods are also expensive, not easily transportable, and can be cumbersome to use on certain projects.

What is required is a tapping device and method which will work with any variety of drive tools such as wrenches, ratchet sockets and impact drivers to greatly increase the speed of the tapping process.

### SUMMARY

There is provided a tapping device which has an elongate body with a first end and a second end. A thread cutting portion is provided toward the first end and an end section for fitting to a drive tool is provided at the second end. A shank portion is deposed between the cutting portion and the end section. The thread cutting portion includes helical thread cutting edges. Relief flutes are provided along the thread cutting portion. The end section is a hexagonal head adapted to receive a drive tool.

A stop is provided on the shank toward the end section. The flared stop extends radially beyond a diameter of the end section

Another aspect of the invention provides a method of using a tapping device which includes the steps of providing a tapping device as described above and providing a drive tool that has a socket dimensioned to fit over the hexagonal head of the tapping device. A further step includes placing the hexagonal head within the socket of the drive tool such that upon activating the drive tool, the socket imparts a torsional force on the tapping device. Another step includes placing the first end of the tapping device in a bore hole, and activating the drive tool such the socket imparts a torsional force on the tapping device so that the cutting portion cuts threads on the interior surface of the bore hole.

A further aspect of the invention involves a combination of the tapping device described above and a drive tool having a socket dimensioned to fit over the hexagonal head of the tapping device so as to impart a torsional force on the tapping device.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 labelled prior art, is a conventional hand tap and tap wrench.

FIG. 2 is a side view of the tapping device of the present invention

FIG. 3 is an end elevation view of the tapping device illustrated in FIG. 4.

FIG. 4 is a side view of the tapping device with a drive tool.

FIG. 5 is a side view, in section, illustrating the tapping device in use.

FIG. 6 is a side elevation view of a variation of the tapping device.

### DETAILED DESCRIPTION

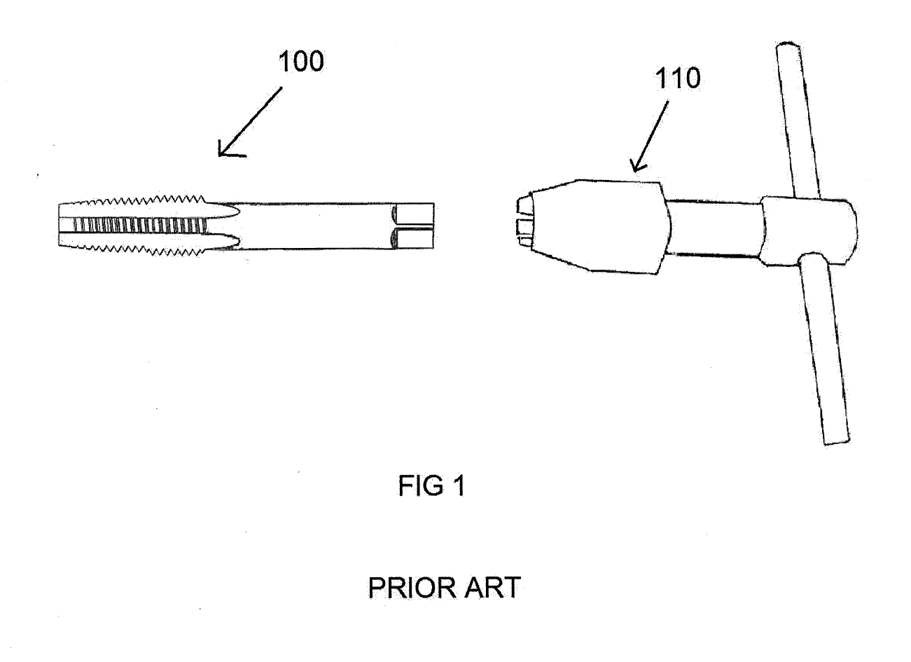

A thread tapping device generally identified by reference numeral 10, will now be described with reference to FIGS. 1 through 6.

### Prior Art

Referring to FIG. 1 and labelled as “prior art” there is illustrated a conventional hand tap generally referenced by numeral 100. The conventional hand tap 100 with a “t” style tap wrench 110 which is operated manually.

### Structure and Relationship of Parts:

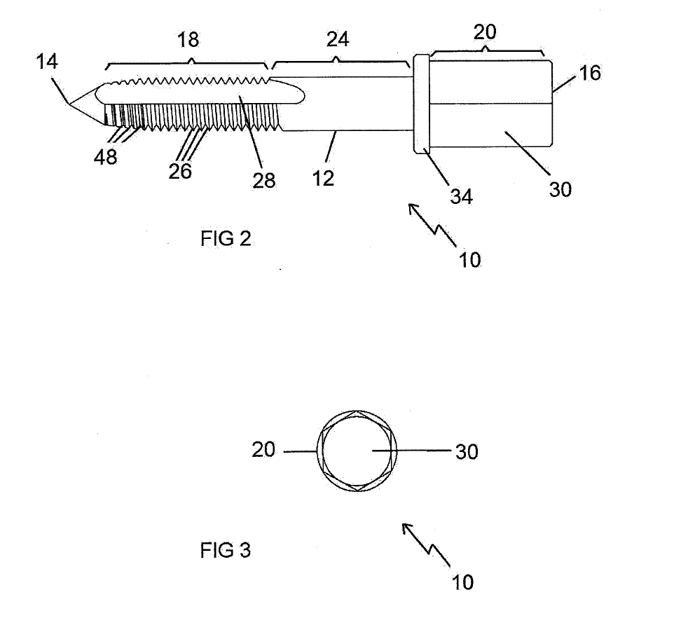

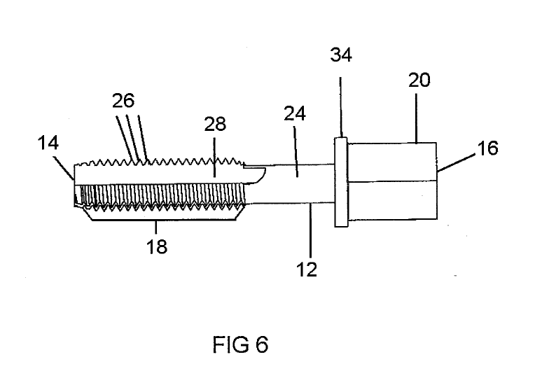

Referring to FIG. 2, there is illustrated the tapping device of the present invention generally referenced by numeral 10. The tapping device 10 has an elongate body 12 with a first end 14 and a second end 16. A thread cutting portion 18 is provided toward the first end 14. An end section 20 for fitting to a drive tool 22 as illustrated in FIG. 6, is provided at the second end 16. A shank portion 24 is disposed between the cutting portion 18 and the end section 20.

Referring again to FIG. 2, the thread cutting portion 18 includes helical thread cutting edges 26. Relief flutes 28 are provided along the cutting portion 18 which intersects the thread cutting edges 26. In the illustrated embodiment, the relief flutes 28 run perpendicular to the direction of the thread cutting edges 26, however it will be appreciated that the path of the relief flutes 28 could be off set or curved as well.

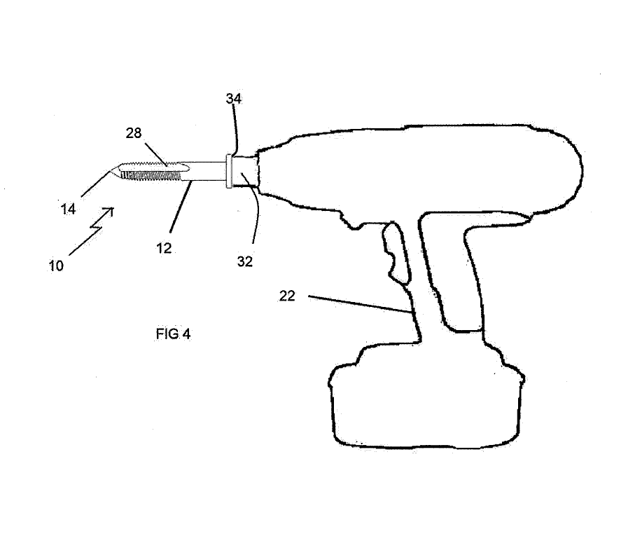

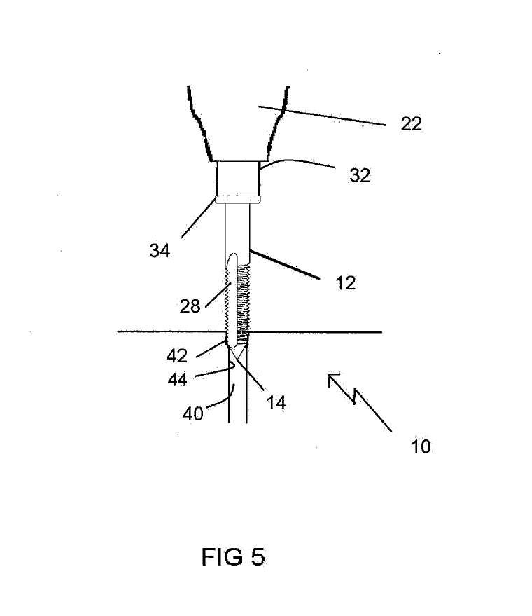

Referring to FIG. 3, the end section 20 is a hexagonal head 30 that is dimensioned to fit into a socket 32 that is carried on an impact driver 22 shown in FIG. 4. Referring again to FIG. 4, it will be appreciated that impact drivers 22 could also be one of an impact wrench, an air wrench, an air gun, a rattle gun, or torque gun. It will also be appreciated that tapping device could also work with any standard wrenches, ratchet sockets or other tools which are adapted to receive the hexagonal head 30 of the tapping device 10. It will also be appreciated that as sockets 32 come in a variety of sizes, the end section 20 will also be available in a variety of sizes as described herein.

Referring to FIG. 2, a flared stop 34 is provided on the shank portion 24 adjacent to the end section 20 to limit tangential force while the cutting portion 18 is cutting threads 42 on the interior surface 44 of the bore hole 40. t Flared stop 34 is annular and adapted to reduce tangential force and maximize torque transfer from the driver 22 the tapping device 10. Flared stop 34 extends radially outward beyond the diameter of the hexagonal head 30 is received within the socket 32 carried by the driver 22, the flared stop 34 abuts against the socket 32 as illustrated in FIG. 5 and FIG. 6. Flared stop 34 can be adjacent to end section 20 or spaced from the end section 20 but should be positioned such that it will abut against the end 31 of the socket 32 to absorb force from the socket of the drive tool 22. Flared stop 34 can be can extend continuously and circumferentially outward beyond the diameter of the hexagonal head 30 is illustrated in FIG. 5, or it can have different configurations. For example, flared stop 34 can be interrupted with only portions extending beyond the diameter of the hexagonal head 30. It can be flat, or it can have a groove to receive the end 31 of socket 32.

### Operation:

The use and operation of the tapping device 10 will now be described with reference to FIGS. 1 through FIG. 6. To use the tapping device 10 as described above, the end section 20 illustrated in FIG. 2 and FIG. 3, is fitted into and received by the socket 32 of the drive tool 22 illustrated in FIG. 4. The first end 14 of the body 12 of the tapping device 10 may be tapered as illustrated in FIG. 2, or may be truncated as illustrated in FIG. 6, depending on the selected application. The embodiment illustrated in FIG. 6 the first end 14 is truncated or flat to enable the tapping device 10 to cut threads to the bottom of a blind hole 40. In the embodiment illustrated in FIG. 2, the end 14 is tapered to assist in aligning and starting the tapping device 10 into an untapped bore hole 40.

Referring to FIG. 5, the drive tool 22 is then activated and the first end 14 of the tapping device 10 is inserted into a bore hole 40 that is smaller in diameter than the cutting portion 18. Referring to FIG. 5, in use the drive tool 22 imparts a torsional force on the tapping device 10 so that the cutting portion 18 drives into the bore hole 40 cutting threads 42 on an interior surface 44 of the bore hole 40. The flared stop 34 provided on the shank portion 24 adjacent to the end section 20 distributes torque directly into the tapping device 10 increasing the effectiveness of the tapping device 10 in cutting threads 42 on the interior surface 44 of the bore hole 40. As the cutting portion 18 drives into the bore hole 40, relief flutes 28 that are provided along the cutting portion 18 allow excess cutaway material or chips to be removed from the tapping device 10 during use.

Referring to FIG. 5, as the tapping device 10 is driven through the hole at a constant speed by the drive tool 22, breakage is reduced and the tapping speed is dramatically increased. In comparison, a conventional hand driven tap 100 such as that illustrated in FIG. 1, is rotated around the bore hole 40 at irregular speeds increasing the torque demands on the tap 100 and contributing to breakage.

The tapping device 10 can be manufactured in a number of sizes such that the hexagonal head 30 corresponds in size and dimension with the hexagonal heads of standard sized bolts. Examples of standard sizes could include ¼″ 5/16″ ⅜″ and ½″ sizes. As a result, users can select the tapping device 10 which has the hexagonal head 30 that matches the size and dimension of a hexagonal head of a bolt (not illustrated) that will subsequently threaded into the bore hole 40. The result is that the same driver 22 can used for both the tapping device 10 and the bolt so that user operator is able to maintain the driver 22 in their hands and simply swap out the tapping device 10 for the bolt and continue with installation of the bolt in the bore hole 40. This eliminates the inconvenience of the step of swapping tools and increases efficiency.

The tapping device 10 illustrated in FIG. 2 is designed to dramatically speed up tapping workflow. Depending on the skill of the user and the type of material being tapped, approximately 70 to 100 holes can be threaded within 15 minutes using a powered drive tool 22 such as an impact driver. This represents about estimated 100 minutes of labour saved over the life of one tap device 10. In contrast, using conventional hand tap 100 with a “t” style tap wrench 110 as illustrated in FIG. 1 can take between 5 to 7 minutes to thread a hole.

Tapping device 10 can also be used with drive tools 22 that are manually operated such as such as standard wrenches, ratchet sockets or other tools which are adapted to receive the hexagonal head 30 of the tapping device 10. This allows the tapping device 10 to be used in situations where a powered drive tool cannot be used or is not desirable. For example, in smaller or awkward spaces, it may be preferable to use a manual tool. Again there can be a time saving, in that the same driver 22 can used for both the tapping device 10 and the bolt so that user operator is able to maintain the driver 22 in their hands and simply swap out the tapping device 10 for the bolt and continue with installation of the bolt in the bore hole 40. This eliminates the inconvenience of the step of swapping tools particularly in small or awkward spaces.

It will be appreciated that the tapping device 10 can be made out of numerous materials including but not limited to HSS, steel, cobalt and other hardened metals. It will also be appreciated that the diameter and length of the elongate body 12 and shank portion 24 can vary as desired. A full sized shank portion 24 maximizes strength as well as in the ease of reversal of tap device 10 from a work piece.

It will also be appreciated that while the tapping device 10 is illustrated as being used with a power tool 22, it can also be used with use any standard wrenches, ratchet sockets or other tools which are adapted to receive the hexagonal head 30 of the tapping device 10.

### Variations:

The thread cutting edges 26 of the cutting portion 18 of the tapping device 10 illustrated in FIG. 2, may feature a nitrate coating to extend the life of the tapping device 10.

Referring to FIG. 2, the first end 14 of the body 12 of the tapping device 10 can feature an initial six thread taper arrangement 48 for faster starts thereby further improving the tapping speed.

The end section 20 for fitting to a drive tool 22 as illustrated in FIG. 6 can be dimension to fit any size or shape of sockets. Traditionally, standard wrenches, ratchet sockets or impact drivers utilize sockets having a six point (hexagonal) shape, however it is conceivable to use a shape and dimension to fit four point (square), 12-point (double-hexagonal) configurations, 8-point (double-square), and even 8-point (octagon sockets)

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A tapping device, comprising;
an elongate body having a first end and a second end;
a thread cutting portion is provided toward the first end:
an end section for fitting to a drive tool is provided at the second end; and
a shank portion is deposed between the cutting portion and the end section.

2. The tapping device of claim 1, wherein the thread cutting portion includes thread cutting edges.

3. The tapping device of claim 1 wherein the thread cutting portion includes relief flutes.

4. The tapping device of claim 2 wherein the thread cutting edges are helical.

5. The tapping device of claim 1 wherein the end section for fitting to a drive tool is a hexagonal head.

6. The tapping device of claim 1 wherein at least one stop is provided on the shank toward the end section.

7. The tapping device of claim 6 wherein the stop extends radially beyond a diameter of the end section.

8. A method of using a tapping device comprising the steps of:
providing a tapping device having an elongate body having a first end and a second end, a thread cutting portion provided toward the first end, a hexagonal head for fitting to a tool provided at the second end, and a shank portion is deposed between the cutting portion and the hexagonal head, the thread cutting portion includes thread cutting edges and relief flutes;
providing a drive tool having a socket dimensioned to receive the hexagonal head of the tapping device; and
placing the hexagonal head within the socket of the drive tool such that upon activating the drive tool, the socket imparts a torsional force on the tapping device.

9. The method of claim 8 further including the step of placing the first end of the tapping device in a hole, activating the drive tool such the socket imparts a torsional force on the tapping device so that the cutting portion cuts threads on the interior surface of the hole.

10. The method of claim 8 wherein the drive tool is one of a wrench, socket wrench or impact driver.

11. The method of claim 8 wherein at least one stop is provided on the shank adjacent to the end section to maximize torque transfer force while cutting portion is cutting threads.

12. In combination:
a tapping device having an elongate body having a first end and a second end, a thread cutting portion provided toward the first end, a hexagonal head for fitting to a drive tool provided at the second end, and a shank portion is deposed between the cutting portion and the end section, the thread cutting portion includes thread cutting edges and relief flute;
a drive tool having a socket dimensioned to receive the hexagonal head of the tapping device so as to impart a torsional force on the tapping device upon activation of the drive tool.

13. The combination of claim 12 wherein the drive tool is one of a wrench, socket wrench or impact driver.
